(19) United States
(12) Patent Application Publication
(10) Pub. No.: US 2010/0023263 A1
(43) Pub. Date: Jan. 28, 2010

(54) Position Detection Method And Position Detection Apparatus For A Preceding Vehicle And Data Filtering Method

(75) Inventor: Shunji Miyahara, Yokohama (JP)

Correspondence Address: DICKINSON WRIGHT PLLC, 1875 Eye Street, NW, Suite 1200, WASHINGTON, DC, 20006, US

(73) Assignee: VISTEON GLOBAL TECHNOLOGIES, INC., Van Buren Township, MI (US)

(21) Appl. No.: 12/508,682

(22) Filed: Jul. 24, 2009

(30) Foreign Application Priority Data
Jul. 28, 2008 (JP) 2008-194014

(51) Int. Cl. G06F 7/00; G06F 17/10

(52) U.S. Cl. 701/300; 708/322

(57) ABSTRACT

A method for detecting the position of a preceding vehicle (2) in relation to an same-vehicle (1), comprising a step of acquiring a primary data set having vehicle range information rᵢ and lateral position information Lᵢ, Rᵢ; a step of linear regression processing for acquiring a secondary data set having vehicle range information rᵢ wherein the deviation with the acquired linear regression line is at or below a prescribed threshold value and corresponding lateral position information Lᵢ, Rᵢ; a step of clustering processing for performing clustering processing on the lateral position information Lᵢ, Rᵢ in the secondary data set and acquiring a tertiary data set having lateral position information Lᵢ, Rᵢ in the largest cluster and corresponding vehicle range information rᵢ; and a step of position information calculation for calculating the vehicle range and lateral position at the present time t₀ using the tertiary data set.

### CROSS REFERENCE TO RELATED APPLICATION

This application claims the benefit of Japanese Patent Application No. 2008-194014 filed Jul. 28, 2008, entitled “Position Detection Method And Position Detection Apparatus For A Preceding Vehicle And Data Filtering Method,” the entire disclosure of this application being incorporated by reference.

### BACKGROUND OF THE INVENTION

1. Technical Field

The present invention pertains to a position detection method and a position detection apparatus for a preceding vehicle and a data filtering method, and in particular to a position detection method, a position detection apparatus, and a data filtering method usable with this position detection method making use of vehicle range information and lateral position information as preceding vehicle position data.

2. Discussion

Conventionally, in driving support systems such as adaptive cruise control (ACC) and low speed follower (LSF), a camera or other image capture means and a laser is used to measure the preceding vehicle, and the position data for the preceding vehicle in relation to the same-vehicle is calculated based on this measurement data. Position data includes vehicle range information between the same-vehicle and the preceding vehicle and lateral information for the preceding vehicle in relation to the same-vehicle.

In addition, this position data calculation processing is generally performed to remove noise data from the measured data using various data screening processes in order to improve the reliability of the position data. As a result, the precision of the driving support system can be improved.

However, the vehicle range and the amount of change in the relative speed between the following vehicle (the same-vehicle) and the preceding vehicle is generally sizable, but there is almost no change in the lateral position and the relative speed in a lateral direction. As a result, the statistical characteristics in data processing differ between vehicle range information and lateral position information. Specifically, vehicle range information has comparatively high time dependency, whereas lateral position information has low time dependency. Consequently, noise data could not be fully removed with conventional data screening processing, and a risk existed of position data being calculated including a comparatively large error component.

### SUMMARY OF THE INVENTION

The present invention was devised in order to solve this problem, and an aim of the invention is to provide a position detection method and a position detection apparatus capable of improving the precision of calculations of position data for a preceding vehicle. Also, an aim of the present invention is to provide a data filtering method capable of removing noise data precisely and efficiently from data having a combination of information possessing time dependency and information having lesser time dependency.

In order to achieve the aims stated above, the present invention provides a position detection method for detecting the vehicle range and lateral position of a preceding vehicle in relation to a same-vehicle, having a step of acquiring first data based on a combination of a plurality of vehicle range information relating to the vehicle range from the present time to a prescribed prior time and lateral position information relating to the lateral positions corresponding to the vehicle range information; a step of linear regression processing for performing linear regression processing on the plurality of vehicle range information in the first position data and for acquiring second position data having vehicle range information for which the deviation from the acquired linear regression line is at or below a prescribed threshold value and lateral position information corresponding to the vehicle range information; a step of clustering processing for performing clustering processing on the lateral position information in the second position data and acquiring third position data having position data for the largest cluster and vehicle range information corresponding to the position data; and a step of position information calculation for calculating the vehicle range and the lateral position at the present time using this third position data.

According to the present invention configured in this manner, noise data is removed from the vehicle range information, for which the time dependency is comparatively large, by performing linear regression processing on a plurality of information from the present time to a prescribed prior time. In contrast, noise data is removed from the lateral position information, for which the time dependency is not as large, by performing clustering processing on a plurality of information from the present time to a prescribed prior time. Accordingly, in the present invention, since data filtering is performed in accordance with the statistical characteristics of vehicle range information and lateral direction information, noise data can be removed efficiently and precisely. As a result, with the present invention, the precision can be improved of position detection of a preceding vehicle.

Also, in the present invention, in the step of position information calculation, linear regression processing may be performed on the vehicle range information in the third position data in order to calculate the vehicle range at the present time, and averaging processing may be performed on the lateral position information in the third position data in order to calculate the lateral position. According to the present invention configured in this manner, the vehicle range at the present time is calculated by applying linear regression processing to the vehicle range information, which possesses time dependency, while the lateral position at the present time is calculated by applying an averaging processing to the lateral position information, which has less time dependency, based on position data from which noise data has been removed.

Also, after the step for acquiring the first position data, the present invention may include a step of determination for determining whether or not the plurality of vehicle range data in the first position data possesses time dependency, wherein, in this step of determination, in a case in which a determination is made that the plurality of vehicle range information in the first position data possesses time dependency, the step of linear regression processing is performed; and wherein, in this step of determination, in a case in which a determination is made that the plurality of vehicle range information in the first position data does not possess time dependency, clustering processing is performed on the plurality of vehicle range information in the first position data, and a process is performed in which is acquired second position data having vehicle range information in the largest cluster and the corresponding lateral information.

According to the present invention configured in this manner, since the vehicle range information is not necessarily limited to information possessing high time dependency, in a case in which the vehicle range information does possess high time dependency, linear regression processing is applied, while in a case in which the vehicle range information does not possess high time dependency, clustering processing is applied in the same manner as with the lateral position information.

In addition, in order to achieve the aims stated above, the present invention provides a preceding vehicle position detection apparatus for detecting the vehicle range and lateral position of a preceding vehicle in relation to a same-vehicle, having position data acquisition module for acquiring first position data having a combination of a plurality of vehicle range information relating to the vehicle range from the present time to a prescribed previous time and lateral position information relating to the lateral positions corresponding to the vehicle range information; first screening module for performing linear regression processing on the plurality of vehicle range information in the first position data and for acquiring second position data having vehicle range information for which the deviation from the acquired linear regression line is at or below a prescribed threshold value and lateral position information corresponding to the vehicle range information; second screening module for performing clustering processing on the lateral position information in the second position data and acquiring third position data having position data for the largest cluster and vehicle range information corresponding to the position data; and position calculation module for calculating the vehicle range and the lateral position at the present time using this third position data.

Also, in the present invention, in the position information calculation module, the vehicle range at the present time is calculated by performing linear regression processing on the vehicle range information in the third position data, while the lateral position is calculated by performing averaging processing on the lateral position information in the third position data.

Also, in the present invention, preferably, in the first screening module, in a case in which a determination is made that the plurality of vehicle range information in the first position data possesses time dependency, linear regression processing is performed, while in a case in which a determination is made that the plurality of vehicle range information in the first position data does not possess time dependency, clustering processing is performed on the plurality of vehicle range information in the first position data, and a second position data is acquired having vehicle range information in the largest cluster and the corresponding lateral information.

In addition, in order to achieve the aims stated above, the present invention provides a data filtering method having a combination of time-dependent information having time dependency and non-time-dependent information for which the time dependency is smaller than the time-dependent information, having a step of acquiring first data having a combination of a plurality of time-dependent information from the present time to a prescribed prior time and non-time-dependent information corresponding to the time-dependent information; a step of acquiring second data in which linear regression processing is performed on the plurality of time-dependent information in the first data, having time-dependent information for which the deviation from the acquired linear regression line is at or below a prescribed threshold value and non-time-dependent information corresponding to this time-dependent information; a step of acquiring third data in which clustering processing is performed on the non-time-dependent information in the second data, having non-time-dependent information for the cluster with the largest cluster number and time-dependent information corresponding to this non-time-dependent information; and a step for calculating the time-dependent information and the non-time-dependent information at the present time using the third data.

According to the present invention configured in this manner, noise data is removed from time-dependent information possessing time dependency by performing linear regression processing on a plurality of information from the present time to a prescribed prior time, while on the other hand, noise data is removed from non-time-dependent information, for which time dependency is lower, by performing clustering processing on a plurality of information from the present time to a prescribed prior time. In this manner, in the present invention, since data filtering is performed according to the magnitude of the time dependency, noise data can be removed efficiently and precisely.

According to the position detection method and the position detection apparatus for a preceding vehicle of the present invention, the precision of calculation of position data for the preceding vehicle can be improved. In addition, according to the data filtering method of the present invention, noise data can be removed precisely and efficiently from data having a combination of information possessing time dependency and information possessing lesser time dependency.

### BRIEF DESCRIPTION OF THE DRAWINGS

In the following section, a position detection apparatus and a position detection method according to a preferred embodiment of the present invention will be described in reference to drawings.

FIG. 1 is a descriptive chart of position detection of a preceding vehicle;

FIG. 2 is a configuration chart for a position detection apparatus;

FIG. 3 is a graph showing temporal fluctuations in position data (initial data) for performing position detection processing;

FIG. 4 is a flowchart of position detection processing;

FIG. 5 is a graph showing one example of data screening processing (cluster processing); and

FIG. 6 is a graph showing one example of clustering processing of lateral position information.

### DETAILED DESCRIPTION OF THE PREFERRED EMBODIMENT

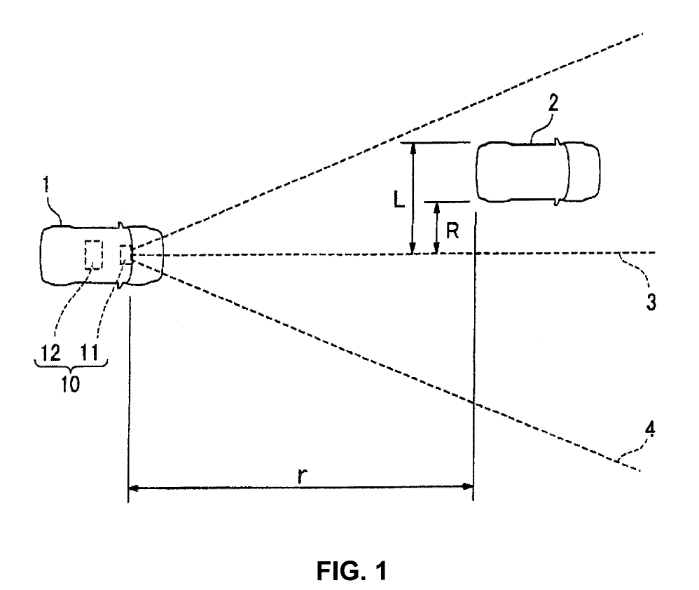

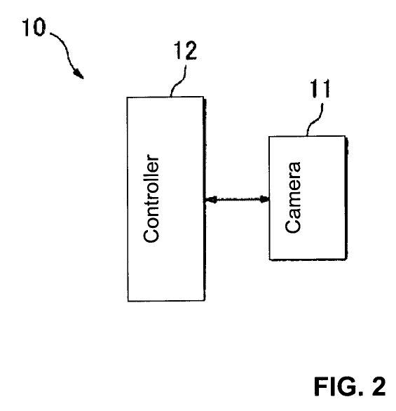

First, the overall configuration of a position detection apparatus 10 of the present embodiment will be described using FIG. 1 and FIG. 2. The position detection apparatus 10 is mounted on the vehicle 1, and has a camera 11 and a controller 12. The camera 11 is disposed on the central axis line in the vehicle width direction of the vehicle 1, and is attached to the vehicle 1 so as to captures images ahead of the vehicle along the axis line 3. Specifically, the camera 11 is a single CCD camera capturing images of an image capture domain 4 having a prescribed angle domain every prescribed sampling time T and sending the images to the controller 12. In the present embodiment, the sampling time T is 0.1 seconds. However, the sampling time T is not limited to this value but may be set to any value in accordance with the design.

The controller 12 is a microcomputer having a CPU, memory, and I/O devices, etc., and is configured to calculate vehicle range information r, the distance along the axis line 3 between the same-vehicle 1 and the preceding vehicle 2, and the lateral position information L, R expressing the lateral direction distance of the preceding vehicle 2 in relation to the axis line 3. The lateral position information L, R indicates the left edge position and the right edge position, respectively, of the preceding vehicle 2.

The controller 12 calculates the positioning data, consisting of the range information r between the same-vehicle 1 and the preceding vehicle 2 and the lateral position information L, R every sampling time T. Also, the controller 12 calculates position data for a vehicle range re and lateral positions Le and Re at present time t0 based on vehicle range information r and lateral position information L, R from the present time t0 to up until before a prescribed time. This position data is provided to the driving support system of the vehicle 1.

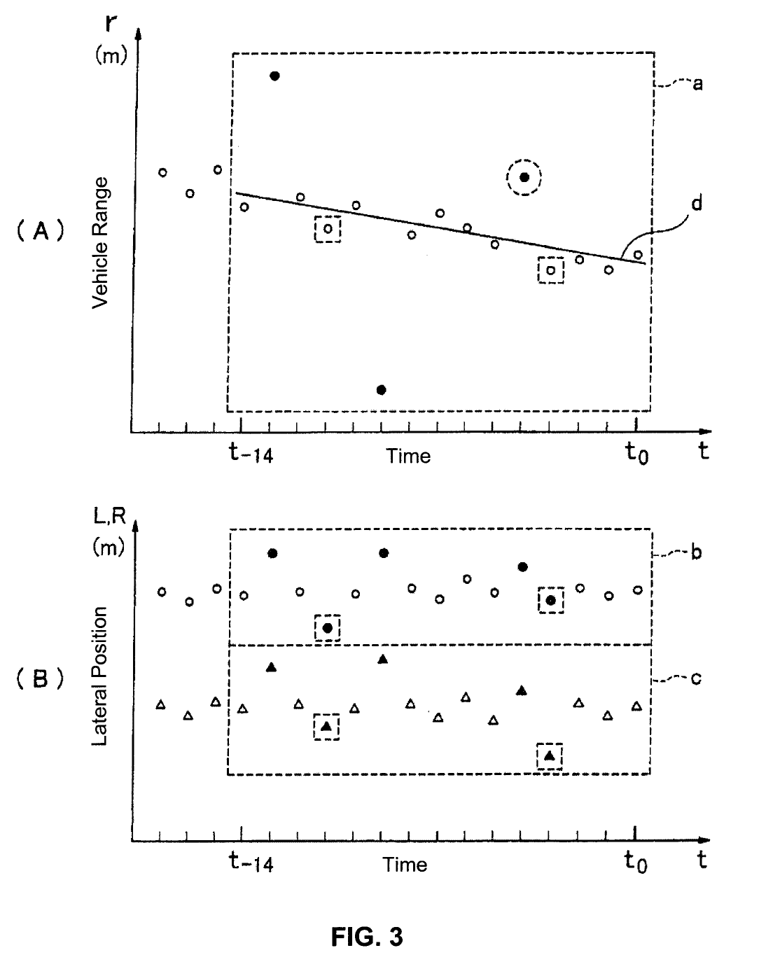

Next, the position detection processing of the controller 12 will be described based on FIG. 3 through FIG. 6. The controller 12 calculates and stores in internal memory the position data (initial position data), consisting of vehicle range information r and the lateral position information L, R, in real time using a known algorithm (see U.S. Patent Application No. 2005/0244003, Specification Item No. 4) based on image data sent from the camera 11 every sampling time interval T. Consequently, in the present embodiment, position data is accumulated in internal memory every 0.1 seconds. Hereafter, this position data will be referred to as initial position data.

The vehicle range information r normally has comparatively high time dependency, and corresponds to the time-dependent information of the present invention, whereas the lateral position information L, R normally has lower time dependency than the vehicle range information r, and corresponds to the non-time-dependent information of the present invention. In the present embodiment, measurement data for calculating the position data is the image data from the camera 11. However, the measurement data is not limited to this image data, but may also be laser data and measurement data from other radar.

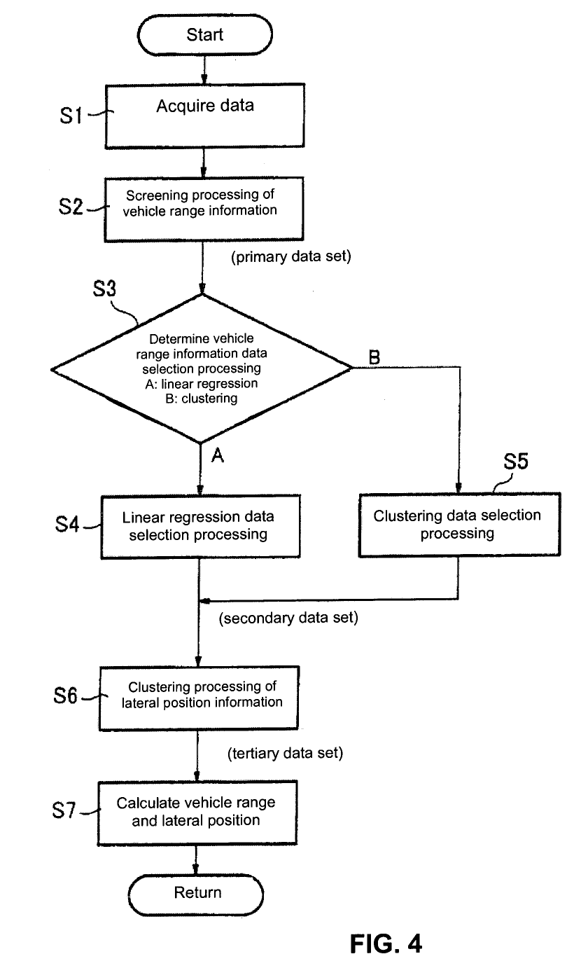

FIG. 3 shows changes over time in the position data for vehicle range information r (FIG. 3(A)) and lateral position information L, R (FIG. 3(B)) as calculated by the controller 12 according to the algorithm described above. FIG. 3 shows temporal change to the initial data from the present time t₀ to approximately 2 seconds prior. The circular marks in FIG. 3(A) indicate the vehicle range information r, while the circular marks in FIG. 3(B) indicate the lateral position information L, and the triangular marks indicate the lateral position information R. The initial position data shown in FIG. 3 includes a noise component, and the controller 12 performs the position detection processing shown in FIG. 4 and calculates the position data for the present time t₀ (rₑ, Lₑ, Rₑ) based on the initial position data shown in FIG. 3.

The controller 12 repeatedly performs the position detection processing shown in FIG. 14 at a prescribed time interval. In other words, the controller 12 calculates the initial position information based on the image data from the camera 11 and performs position detection processing at a point in time when the initial position data is stored in internal memory. First, of the initial position data stored in internal memory, the controller 12 reads from internal memory initial position data from the present time t0 to a prescribed prior time (1.5 seconds, in this embodiment) (Step S1).

In Step S1, the controller 12 reads time intervals tᵢ (i=0, −1, −2, . . . −14), or in other words, initial position data (vehicle range information rᵢ, lateral position information Lᵢ, Rᵢ) in 15 consecutive sampling intervals, including the present time t₀. FIG. 3 shows initial position data yielded by data enclosed in area a (vehicle range information rᵢ, area b (lateral position information Lᵢ) and area c (lateral position information Rᵢ).

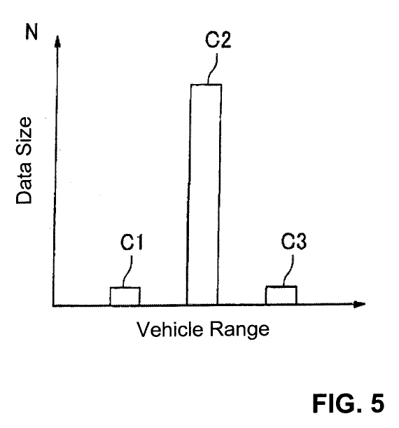

Next, the controller 12 performs data screening processing (pre-processing) on the 15 units of vehicle range information rᵢ (Step S2). This processing is intended to remove unambiguous noise data having no diachronic continuity and differing significantly in level from other numerical value groupings. In Step S2, the controller 12 first performs clustering processing (for example, K averaging method) on the 15 units of vehicle range information rᵢ. As one example, FIG. 5 shows the results of clustering processing on the vehicle range information rᵢ in the example in FIG. 3. FIG. 5 shows the data size of each cluster (of a plurality of clusters) as classified.

The controller 12 removes as noise data vehicle range information ri in clusters wherein the number of vehicle range information rᵢ in units is small and the distance from other clusters is large. In the example of FIG. 5, clusters C1 and C3 are removed. Also, the controller 12 similarly removes the lateral position information Lᵢ, Rᵢ corresponding to the vehicle range information rᵢ removed as noise data. The term “corresponding” referring to vehicle range information rᵢ and lateral position Lᵢ, Rᵢ signifies that the information was measured during the same measurement time interval (sampling interval).

In the example in FIG. 3, the vehicle range information r₋₁₃ and r₋₉ having times of t₋₁₃ and t₋₉ isolated from other information (round black marker) are removed. Moreover, in conjunction with this action, the corresponding L₋₁₃, L₋₉, R₁₃, and R₉ are removed. As a result, acting as position data acquisition module, the controller 12 acquires a primary data set (1st position data) consisting of 13 units of information, and stores [the data set] in internal memory. In the example in FIG. 3, the primary data set consists of the vehicle range information rᵢ and the lateral position information Lᵢ, Rᵢ (i=0, −1, −2, −3, −4, −5, −6, −7, −8, −10, −11, −12, −14).

In the present embodiment, the K averaging method is used as the clustering processing, but is not limited to this method. Other clustering methods may also be employed. In addition, in the present embodiment, clustering processing is performed as the data screening processing (pre-processing); however, the data screening is not limited to this process. Other processing methods may be performed provided those methods are capable of removing unambiguous noise components. Furthermore, in the present embodiment, data screening processing (pre-processing) is performed. However, this processing need not be performed.

Next, acting as the first screening module, the controller 12 performs vehicle range information analysis processing on the primary data set (Steps S3-S5). In this processing, the controller 12 determines whether or not the vehicle range information rᵢ possesses the prescribed time dependency or greater (Step S3). Also, in a case in which the controller 12 determines that the vehicle range information rᵢ possesses time dependency, linear regression processing is performed (Step S4), while in a case in which the controller determines that the vehicle range information rᵢ does not possess time dependency, clustering processing is performed (Step S5). In this manner, in the present embodiment, the data screening processing is modified in accordance with the data characteristics of the vehicle range information rᵢ, and as a result, the precision of the position detection of the preceding vehicle 2 can be improved.

In Step S3, the controller 12 first performs linear regression processing (for example, least square method processing) on the primary data set. Next, the controller 12 calculates the standard deviation from the linear regression line (for example, line d in FIG. 3) obtained from the linear regression processing. In addition, in a case in which the standard deviation for the vehicle range information rᵢ is equal to or less than a prescribed threshold value, the controller 12 determines that the vehicle range information rᵢ possesses time dependency (Step S3; A). However, in a case in which the standard deviation of the vehicle range information rᵢ exceeds the prescribed threshold value, the controller 12 determines that the vehicle range information does not possess time dependency (Step S3; B). The threshold value described above is calculated based on experimentation, and is stored in advance in the internal memory of the controller 12.

In Step S4, the controller 12 removes as noise components the elements of vehicle range information rᵢ in the primary data set which have a deviation from the linear regression line d greater than the prescribed threshold value. The controller 12 also removes the lateral position information Lᵢ, Rᵢ corresponding to the vehicle range information rᵢ removed as noise components. The threshold value for the deviation is calculated experimentally, and is stored in advance in the internal memory of the controller 12. In the example in FIG. 3, the vehicle range information r₋₄ at time t₋₄ (round black mark enclosed by hashed-line circle) is removed. And in conjunction with this action, the lateral position information L₋₄ and R₋₄ at time t₋₄ are also removed. As a result, the controller 12 acquires the remaining un-removed 12 units of vehicle range information rᵢ and the corresponding lateral position information Lᵢ, Rᵢ as a secondary data set (second position data). In the example in FIG. 3, the secondary data set consists of the vehicle range information ri and the lateral position information Li, Ri (i=0, −1, −2, −3, −5, −6, −7, −8, −10, −11, −12, −14).

In Step S5, the controller 12 performs clustering processing (for example, the K averaging method) on the vehicle range information rᵢ in the primary data set. In addition, the controller 12 removes as noise data all data other than the vehicle range information in the largest cluster (cluster having the largest data size of the plurality of classified clusters. As a result, the controller 12 acquires the vehicle range information rᵢ in the un-removed largest cluster and the corresponding lateral position information Lᵢ, Rᵢ as a secondary data set.

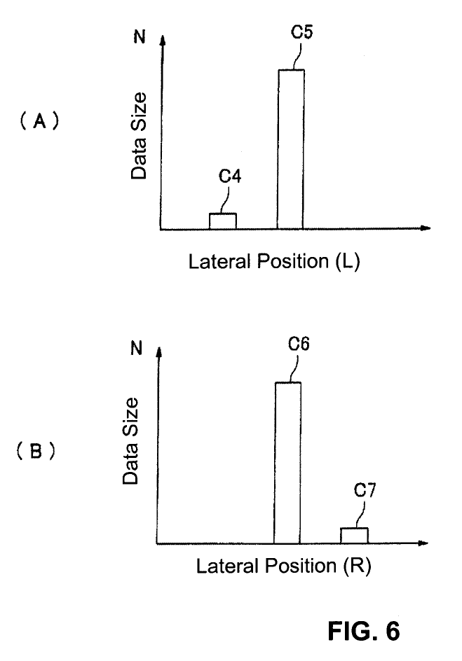

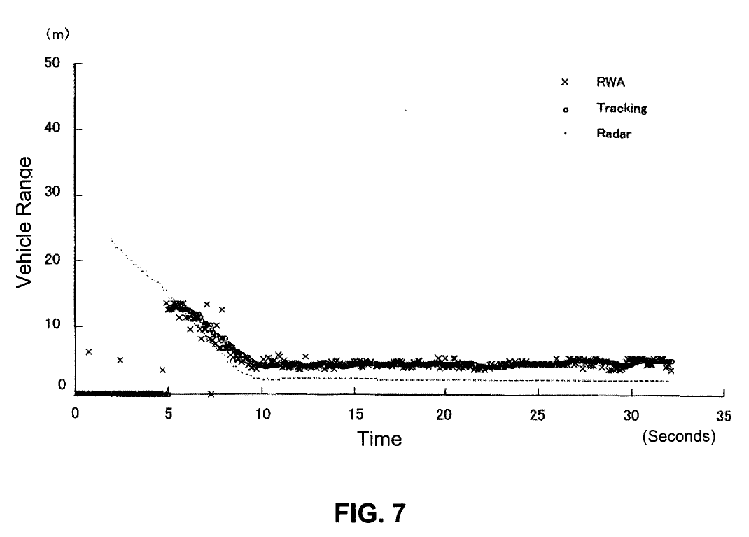

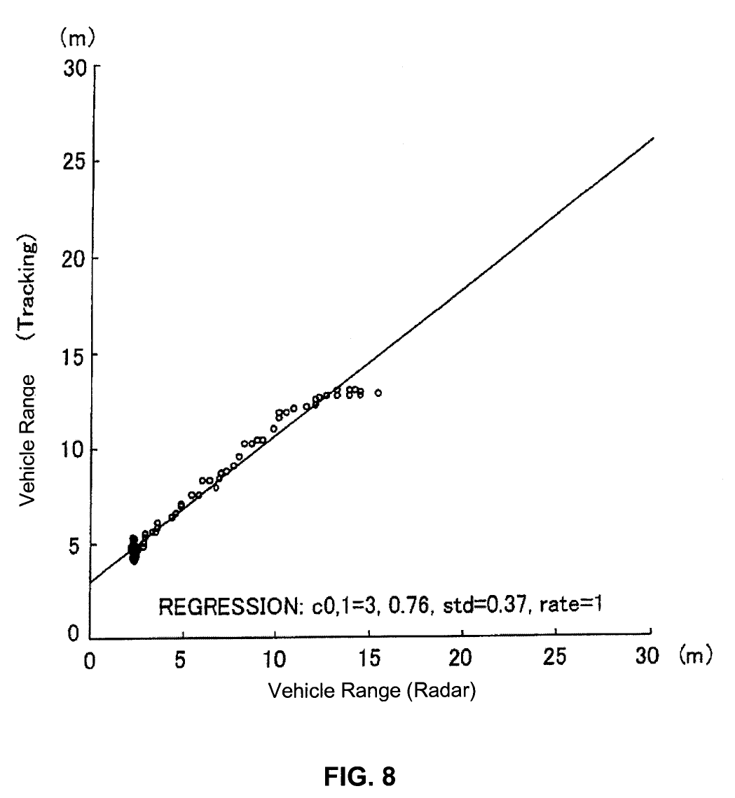

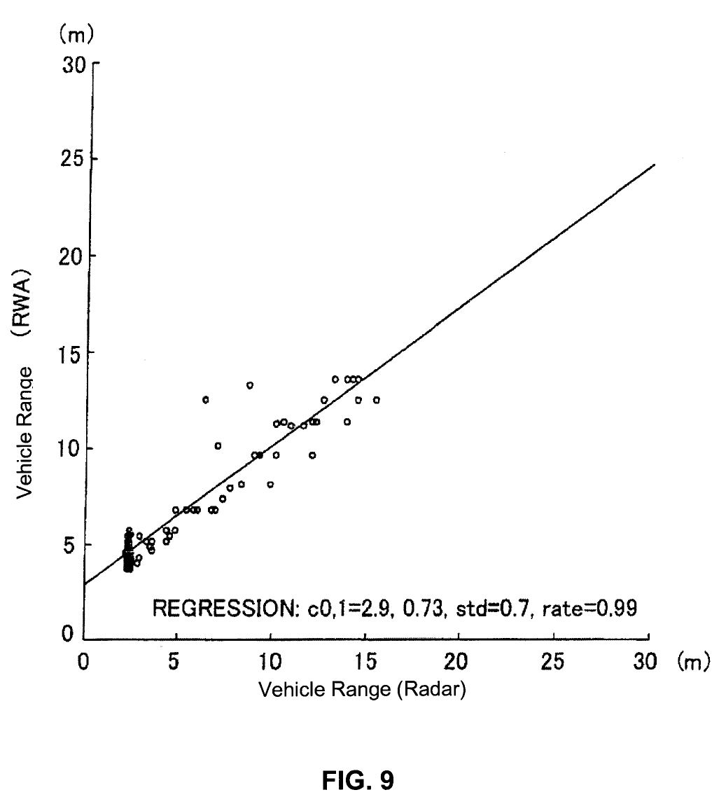

Next, acting as the second screening module, the controller 12 performs lateral position information analysis processing on the secondary data set (Step S6). In Step S6, the controller 12 performs the same clustering processing as in Step S5 (for example, the K averaging method) on the lateral position information Lᵢ, Rᵢ in the secondary data set. FIG. 6(A) and (B) show the results after clustering processing is performed on the lateral position information Lᵢ, Rᵢ in the secondary data set corresponding to the example in FIG. 3. FIG. 6 shows the data size of each classified cluster. In this example, cluster C4 in the lateral position information (L₋₁₁) and cluster C7 in the lateral position information (R₋₃) are removed.

Also removed are the lateral position information R₋₁₁ and the vehicle range information r₋₁₁ corresponding to the cluster C4 (L₋₁₁) and the lateral position information R₋₃ and the vehicle range information r₋₃ corresponding to the cluster C7 (R₋₃). As a result, the controller acquires a tertiary data set (third position data) consisting of the vehicle range information rᵢ and the lateral position information Lᵢ, Rᵢ (i=0, −1, −2, −5, −6, −7, −8, −10, −12, −14).

Next, acting as the position information calculation module, the controller 12 calculates the vehicle range rₑ and the lateral position information Lₑ, Rₑ at the present time t₀ based on the tertiary data set (Step S7). In Step S7, the controller 12 performs linear regression processing on the vehicle range information rᵢ in the tertiary data set. Using the linear regression line calculated by linear regression processing, the controller 12 calculates the vehicle range re between the preceding vehicle 2 and the same-vehicle 1 at the present time t₀. In other words, the value of the linear regression line at the present time t₀ is calculated as the vehicle range rₑ. The vehicle range information possesses time dependency, and so by simply performing linear regression processing instead of averaging processing, the precision of the calculated vehicle range can be improved. Also, the controller 12 performs averaging processing respectively on the lateral position information Lᵢ, Rᵢ in the tertiary data set to calculate the left and right lateral position Lₑ, Rₑ of the preceding vehicle 2. In the calculation of lateral position, the median value of the lateral position information Lᵢ, Rᵢ may be selected instead of performing averaging processing on the lateral position information Lᵢ, R, and the median value may be taken as the lateral position Lₑ, Rₑ.

In Step S7 in the present embodiment, linear regression processing is performed on the vehicle range information rᵢ in the tertiary data set. However, the processing is not limited to this method. In a case in which the Step S5 is executed, the vehicle range information in the tertiary data set may be averaged to calculate the vehicle range rₑ at the present time t₀.

As detailed above, the position detection apparatus 10 for a preceding vehicle of the present embodiment removes noise data by applying linear regression processing to the vehicle range information in accordance with differences in statistical characteristics between the vehicle range information and the lateral position information, and, in order to further elevate the precision of the data, removes noise data by applying clustering processing to the lateral position information. As a result, in the present embodiment, the initial position data, the original data calculated based on image data from the camera 11, can be effectively subjected to filtering processing, and the precision of the ultimately obtained position information at the present time can be greatly improved.

Next, position calculation results using the position calculation apparatus 10 of the present embodiment are shown in FIG. 7 through FIG. 9. In this example, the vehicle range between the preceding vehicle 2 and the same-vehicle 1 is detected over an exemplary span of approximately 32 seconds. In this example, the preceding vehicle 2 is disposed approximately 22 m ahead of the same-vehicle 1 at the time measurement begins, but thereafter gradually draws nearer the same-vehicle 1, and from 10 seconds afterward and thereafter, runs approximately 3 m ahead of the same-vehicle 1.

In addition, in order to check the precision of the measurement, the vehicle range is also measured using a laser radar mounted on the vehicle 1, aside from the position detection apparatus 10. In this example, the laser radar is disposed approximately 2 m ahead of the camera 11, producing a variation of approximately 2 m between position detection data from the position detection apparatus 10 and position detection data from the laser radar. FIG. 7 shows changes over time in 3 types of position detection data: initial position data (labeled as “RWA”), position data of the present embodiment calculated based on the initial position data (labeled as “Tracking”) and position measurement data from the laser radar (labeled “Radar”).

From FIG. 7 it is apparent that initial position data (RWA) and position data according to the present embodiment (Tracking) have a differential of approximately 2 m with respect to position measurement data from the laser radar. Nevertheless, the initial position data (RWA) includes sudden temporal fluctuations of approximately 1 m-2 m in the vehicle progress direction. These fluctuations consist of noise data arising from measurement. In contrast, it is apparent that the sudden temporal fluctuations observed in the initial position data (RWA) are removed by the noise filtering processing described above from the position data according to the present embodiment (Tracking).

In addition, FIG. 8 is a correlation chart for position measurement data from the laser radar and position data according to the present embodiment (Tracking). Each plot represents the vehicle range for each data measurement time interval, with the horizontal axis component representing the magnitude of position measurement data by the laser radar and the vertical axis component representing the position data according to the present embodiment. Also, the line in FIG. 8 is the linear regression line for the plots within a valid domain. The linear regression line is offset by approximately 2 m because of differences in the position of measurement in the forward-rear direction. FIG. 9 is a correlation chart for the position measurement data from the laser radar and the initial position data (RWA), similar to that of FIG. 8.

From FIG. 8 and FIG. 9, it is apparent that the position data according to the present embodiment (Tracking) has a higher correlation with position measurement data from the laser radar, and that the deviation from the linear regression line is smaller. As stated above, from FIG. 7 through FIG. 9 it is apparent that noise filtering can be effectively performed using the present embodiment, and that the precision of detected position data can be improved as a result.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A preceding vehicle position detection method for detecting the vehicle range and lateral position of a preceding vehicle in relation to an same-vehicle, comprising:
acquiring a first data based on a combination of a plurality of individual vehicle range information relating to the vehicle range from the present time to a prescribed prior time and lateral position information relating to the individual lateral positions which correspond to a particular individual vehicle range information;
performing linear regression processing on the plurality of individual vehicle range information in the first position data and for acquiring second position data having vehicle range information for which the deviation from the acquired linear regression line is at or below a prescribed threshold value and lateral position information corresponding to the vehicle range information;
performing clustering processing on the lateral position information in the second position data and acquiring third position data having position data for the largest cluster and vehicle range information corresponding to the position data; and
calculating the vehicle range and the lateral position at the present time using this third position data.

2. The preceding vehicle position detection method of claim 1, wherein, in the step of calculating the vehicle range is performed with linear regression processing on the vehicle range information in the third position data in order to calculate the vehicle range at the present time, and averaging processing is performed on the lateral position information in the third position data in order to calculate the lateral position.

3. The preceding vehicle position detection method of claim 1 further comprising a step of determining whether or not the plurality of vehicle range data in the first position data possesses time dependency, and wherein, a determination is made that the plurality of vehicle range information in the first position data possesses time dependency, the step of linear regression processing is performed; and further wherein, a determination is made that the plurality of vehicle range information in the first position data does not possess time dependency, clustering processing is performed on the plurality of vehicle range information in the first position data, and a process is performed in which is acquired second position data having vehicle range information in the largest cluster and the corresponding lateral information.

4. A preceding vehicle position detection apparatus for detecting the vehicle range and lateral position of a preceding vehicle in relation to an same-vehicle, comprising:
position data acquisition module for acquiring first position data having a combination of a plurality of vehicle range information relating to the vehicle range from the present time to a prescribed previous time and lateral position information relating to the lateral positions corresponding to the vehicle range information;
a first screening module for performing linear regression processing on the plurality of vehicle range information in the first position data and for acquiring second position data having vehicle range information for which the deviation from the acquired linear regression line is at or below a prescribed threshold value and lateral position information corresponding to the vehicle range information;
a second screening module for performing clustering processing on the lateral position information in the second position data and acquiring third position data having position data for the largest cluster and vehicle range information corresponding to the position data; and
a position calculation module for calculating the vehicle range and the lateral position at the present time using the third position data.

5. The vehicle position detection apparatus of claim 4, wherein, in the position calculation module, linear regression processing is performed on the vehicle range information in the third position data in order to calculate the vehicle range at the present time, and averaging processing is performed on the lateral position information in the third position data in order to calculate the lateral position.

6. The preceding vehicle position detection apparatus of claim 4, wherein, in the first screening module, upon determining that the plurality of vehicle range information in the first position data possesses time dependency performs a step of linear regression processing and wherein upon determining that the plurality of vehicle range information in the first position data does not possess time dependency, performs clustering processing on the plurality of vehicle range information in the first position data, and a process is performed in which is acquired second position data having vehicle range information in the largest cluster and the corresponding lateral information.

7. A data filtering method having a combination of time-dependent information having time dependency and non-time-dependent information for which the time dependency is smaller than the time-dependent information, comprising:
a step of acquiring first data having a combination of a plurality of time-dependent information from the present time to a prescribed prior time and non-time-dependent information corresponding to the time-dependent information;
a step of acquiring second data in which linear regression processing is performed on the plurality of time-dependent information in the first data, having time-dependent information for which the deviation from the acquired linear regression line is at or below a prescribed threshold value and non-time-dependent information corresponding to this time-dependent information;
a step of acquiring third data in which clustering processing is performed on the non-time-dependent information in the second data, having non-time-dependent information for the cluster with the largest cluster number and time-dependent information corresponding to this non-time-dependent information; and
a step for calculating the time-dependent information and the non-time-dependent information at the present time using the third data.
